(19) United States
(12) Patent Application Publication
(10) Pub. No.: US 2006/0101075 A1
(43) Pub. Date: May 11, 2006

(54) Method and system for prospectively acquiring ROI based data for retrospective re-analysis

(76) Inventors: Peter Lehel, Oconomowoc, WI (US); Toan Thanh Le, Germantown, WI (US); Kelly Ann Mohr, New Berlin, WI (US); Saad Ahmed Sirohey, Pewaukee, WI (US); David Charles Mack, Waukesha, WI (US)

Correspondence Address: CANTOR COLBURN, LLP, 55 GRIFFIN ROAD SOUTH, BLOOMFIELD, CT, 06002, US

(21) Appl. No.: 10/985,089

(22) Filed: Nov. 10, 2004

(51) Int. Cl. G06F 17/00; G06F 7/00

(52) U.S. Cl. 707/104.1

(57) ABSTRACT

A method and system for prospectively acquiring data of a region of interest for retrospective re-analysis includes obtaining region of interest data and generating property information of the region of interest data. The method also includes analyzing the property information receptive to generating a measurement of the property information. After storing the property information, the property information is retrievable for further analysis.

### BACKGROUND OF THE INVENTION

The present disclosure relates generally to a method and system for prospectively acquiring region of interest (ROI) based data for retrospective re-analysis. Generally, ROI based data is gathered using a data acquisition system. ROI based data is used to obtain property information related to the ROI. The property information may then be analyzed to provide an assessment. Currently, the assessment is commonly disseminated for use or stored, however, the ROI based data is not stored. Failure to store ROI based data means the assessment is limited by the modalities for analysis available at the time of the original data acquisition. An example of the current methods of processing ROI based data relates to coronary artery calcium scoring (CACS). CACS is a clinical tool that identifies high-risk patients early in order to proactively manage patients before they experience undesirable cardiac events. A coronary artery calcium score can be used as a surrogate for age in the determination of individuals who are at high risk for coronary events.

In a typical CACS application, a coronary artery calcium score is obtained by selecting a plurality of ROI where calcium deposits are believed to be present. Image data for each ROI is obtained and assigned a label of artery type. Based on the image data, an application may calculate a coronary artery calcium score, mass, and volume using algorithms associated for determining each.

In at least one known method for calculation of coronary artery calcium scores using a computed tomography (CT) imaging system configuration, an x-ray source projects a fan-shaped beam which is collimated to lie within an X-Y plane of a Cartesian coordinate system, wherein the X-Y plane is generally referred to as an “imaging plane”. An array of radiation detectors, wherein each radiation detector includes a detector element, is within the CT system so as to receive this fan-shaped beam. An object, such as a patient, is disposed within the imaging plane so as to be subjected to the x-ray beam wherein the x-ray beam passes through the object. As the x-ray beam passes through the object being imaged, the x-ray beam becomes attenuated before impinging upon the array of radiation detectors. The intensity of the attenuated beam radiation received at the detector array is responsive to the attenuation of the x-ray beam by the object, wherein each detector element produces a separate electrical signal responsive to the beam attenuation at the detector element location. These electrical signals are referred to as x-ray attenuation measurements.

In addition, the x-ray source and the detector array may be rotated, with a gantry within the imaging plane, around the object to be imaged so that the angle at which the x-ray beam intersects the object constantly changes. A group of x-ray attenuation measurements, i.e., projection data, from the detector array at one gantry angle is referred to as a “view”. A “scan” of the object comprises a set of views made at different gantry angles during one revolution of the x-ray source and the detector array. In an axial scan, the projection data is processed so as to construct an image that corresponds to a two-dimensional slice taken through the object.

As discussed above, one measure of heart disease includes calcium quantity in coronary vessels of the heart. The calcium quantity represents a measurement of the calcification in the coronary vessels. When a patient undergoes a CT scan of the heart, a radiologist or technician can view the resulting images and identify calcium plaque in the heart along with labels of the vessels containing the calcium. The calcium quantity located in the heart can be totaled, resulting in a total calcium score that can be compared to other patients of the same age and having similar characteristics. The total calcium score provides the patient and his or her health care provider one way to measure the patient's risk for coronary events relative to other patients of the same age and having similar characteristics.

A number of discrete pixel elements, which include pixel values expressed in Hounsfield Units (HU), are associated with calcium plaque. There are three scores associated with quantifying the calcium plaque into a total calcium score. The Agatson Janovitz (AJ) score is a popular score among radiologists assessing cardiac images and is widely used. However, it is also the most susceptible to noise. The second score, referred to as a volume score, is used by research radiologists and is more reproducible than the AJ score. However, it is also limited in accuracy by the limitations on slice thickness and voxel dimensions. The third score, a mass score, is the most accurate of the three scores because it corrects for changes in slice thickness.

Current data gathering standards for CACS provide storing the scoring result in a database using one particular algorithm with a predetermined set of parameters. Storing only the scoring result falls short in the ability to re-process ROI based data using either different parameters or algorithms, because the ROI based data used to generate the original scoring result is not stored.

### BRIEF DESCRIPTION OF THE INVENTION

One aspect of the invention is a method for prospectively acquiring region of interest based data for retrospective re-analysis. The method includes obtaining region of interest data and generating property information of the region of interest data. The method also includes analyzing the property information receptive to generating a measurement of the property information. After storing the property information, the property information is retrievable receptive to further analysis.

Another aspect of the invention is a method for prospectively acquiring region of interest based image data for retrospective re-analysis of coronary artery calcium scores. The method includes obtaining patient region of interest image data and generating property information of the patient region of interest image data. The method also includes analyzing the property information receptive to generating a measurement of the property information. After storing the property information, the property information is retrievable receptive to further analysis.

Another aspect of the invention is a system for acquiring region of interest based data for retrospective re-analysis. The system includes a data acquisition system, an object disposed so as to be in communication with the data acquisition system. The data acquisition system generates data of the object. The system also includes a processing device in communication with the data acquisition system. The data processing device includes software, which implements a method. The method implemented by the software includes obtaining region of interest data and generating property information of the region of interest data. The method also includes analyzing the property information receptive to generating a measurement of the property information. After storing the property information, the property information is retrievable receptive to further analysis.

Another aspect of the invention is a computer program product for prospectively acquiring region of interest based data for retrospective re-analysis. The product includes a storage medium readable by a processing circuit and configured to store instructions for execution by the processing circuit. The processing circuit is receptive to obtaining region of interest data and generating a first property information of the region of interest data. The processing circuit is also capable of analyzing the property information receptive to generating a measurement of the property information. After storing the property information, the property information is retrievable receptive to further analysis.

Further aspects of the invention are disclosed herein. The above discussed and other features and advantages of the present invention will be appreciated and understood by those skilled in the art from the following detailed description and drawings.

### BRIEF DESCRIPTION OF THE DRAWINGS

Referring to the exemplary drawings wherein like elements are numbered alike in the several FIGURES:

FIG. 1 is a perspective view of a CT imaging system and a patient disposed for imaging in accordance with an exemplary embodiment;

FIG. 2 is a block schematic diagram of a CT imaging system in accordance with an exemplary embodiment;

FIG. 3 is a block diagram of a method to prospectively acquire region of interest (ROI) based data for retrospective re-analysis in accordance with an exemplary embodiment;

FIG. 4 is a block diagram illustrating further analysis of property information in accordance with an exemplary embodiment;

FIG. 5 is a block diagram illustrating the use of further analysis to assess accuracy of property information in accordance with an exemplary embodiment.

### DETAILED DESCRIPTION OF THE INVENTION

In accordance with an exemplary embodiment of the present invention, while a method, system and computer product for prospectively acquiring region of interest data for retrospective re-analysis are described hereinbelow with reference to a computed tomography (CT) system, it should be understood that the method, system and computer product of the present invention may be applied to other data acquisition systems, such as a magnetic resonance imaging system (MRI), a positron emission tomography system (PET), a single photon emission computed tomography system (SPECT), an ultrasound system, or a X-ray system.

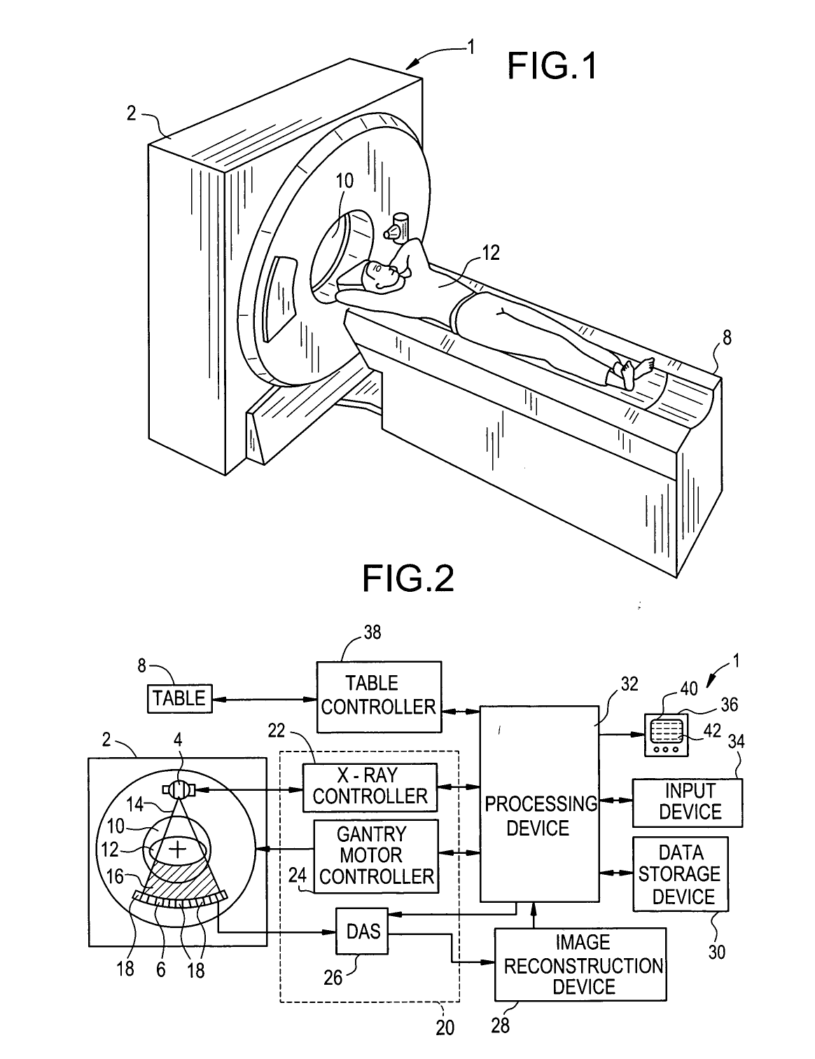

Referring to FIGS. 1-3, a CT imaging system 1 is disposed so as to be communicated with an object 12. CT imaging system 1 generates region of interest ROI data of the object 12 at 44. Property information of the data is generated at 46. Property information is analyzed at 48 and stored at 50. Stored property information is retrievable receptive to further analysis at 52.

An exemplary embodiment of the invention related specifically to CACS is a representative CT imaging system 1 as shown in FIGS. 1 and 2. CT imaging system 1 includes a gantry 2 having an x-ray source 4, a radiation detector array 6, a patient support structure 8 and a patient cavity 10, wherein the x-ray source 4 and the radiation detector array 6 are opposingly disposed so as to be separated by the patient cavity 10. In an exemplary embodiment, a patient 12 is disposed upon the patient support structure 8, which is then disposed within the patient cavity 10. The x-ray source 4 projects an x-ray beam 14 toward the radiation detector array 6 so as to pass through the patient 12. In an exemplary embodiment, the x-ray beam 6 is collimated by a collimate (not shown) so as to lie within an X-Y plane of a Cartesian coordinate system referred to as an “imaging plane”. After passing through and becoming attenuated by the patient 12, the attenuated x-ray beam 16 is received by the radiation detector array 6. In an exemplary embodiment, the radiation detector array 6 includes a plurality of detector elements 18 wherein each of said detector elements 18 receives an attenuated x-ray beam 16 and produces an electrical signal responsive to the intensity of the attenuated x-ray beam 16.

In addition, the x-ray source 4 and the radiation detector array 6 are rotatingly disposed relative to the gantry 2 and the patient support structure 8, so as to allow the x-ray source 4 and the radiation detector array 6 to rotate around the patient support structure 8 when the patient support structure 8 is disposed within the patient cavity 10. X-ray projection data is obtained by rotating the x-ray source 4 and the radiation detector array 6 around the patient 12 during a scan. The x-ray source 4 and the radiation detector array 6 communicate with a control mechanism 20 associated with the CT imaging system 1. The control mechanism 20 controls the rotation and operation of the x-ray source 4 and the radiation detector array 6.

In an exemplary embodiment, the control mechanism 20 includes an x-ray controller 22 communicating with a x-ray source 4, a gantry motor controller 24, and a data acquisition system (DAS) 26 communicating with a radiation detector array 6. The x-ray controller 22 provides power and timing signals to the x-ray source 4, the gantry motor controller 24 controls the rotational speed and angular position of the x-ray source 4, and the radiation detector array 6 and the DAS 26 receive the electrical signal data produced by detector elements 18 and convert this data into digital signals for subsequent processing. In an exemplary embodiment, the CT imaging system 1 also includes an image reconstruction device 28, a data storage device 30 and a processing device 32, wherein the processing device 32 communicates with the image reconstruction device 28, the gantry motor controller 24, the x-ray controller 22, the data storage device 30, an input device 34 and an output device 36. The CT imaging system 1 can also include a table controller 38 in communication with the processing device 32 and the patient support structure 8, so as to control the position of the patient support structure 8 relative to the patient cavity 10.

In accordance with an exemplary embodiment, the patient 12 is disposed on the patient support structure 8, which is then positioned by an operator via the processing device 32 so as to be disposed within the patient cavity 10. The gantry motor controller 24 is operated via processing device 32 so as to cause the x-ray source 4 and the radiation detector array 6 to rotate relative to the patient 12. The x-ray controller 22 is operated via the processing device 32 so as to cause the x-ray source 4 to emit and project a collimated x-ray beam 14 toward the radiation detector array 6 and hence toward the patient 12. The x-ray beam 14 passes through the patient 12 so as to create an attenuated x-ray beam 16, which is received by the radiation detector array 6.

The detector elements 18 receive the attenuated x-ray beam 16, produce electrical signal data responsive to the intensity of the attenuated x-ray beam 16 and communicate this electrical signal data to the DAS 26. The DAS 26 then converts this electrical signal data to digital signals and communicates both the digital signals and the electrical signal data to the image reconstruction device 28, which performs high-speed image reconstruction. This information is then communicated to the processing device 32, which stores the image in the data storage device 30 and displays the digital signal as an image via output device 36. The information communicated to the processing device 32 is referred to as ROI image data. In accordance with an exemplary embodiment, the output device 36 includes a display screen 40 having a plurality of discrete pixel elements 42.

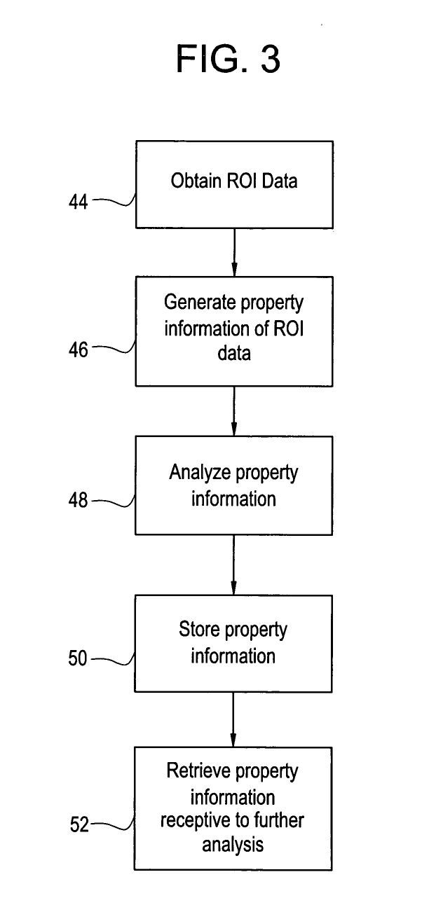

FIG. 3 shows an exemplary embodiment of the invention in which a method for prospectively acquiring region of interest data for retrospective re-analysis is described. ROI data is obtained for a selected ROI as indicated at 44. ROI data is generally obtained by use of a data acquisition system. In an exemplary embodiment, the data acquisition system is a commuted tomography (CT) imaging system as described above referring to FIGS. 1 and 2. However, other data acquisition systems are envisioned including a magnetic resonance (MRI) imaging system, a positron emission tomography (PET) system, a single photon emission computed tomography (SPECT) system, an ultrasound system, or a X-ray system. The data acquisition system obtains ROI data including, but not limited to image data, functional image data, and temporal image data. Further examples of ROI data include voxel data including volume information for a three dimensional ROI, pixel data including area information for a two dimensional ROI, and spatio-temporal data. Spatio-temporal data includes area or volume information over a selected, predetermined time period.

Generating property information of the ROI data, shown generally at 46, is then performed. In an exemplary embodiment, patient ROI image data is used in generating property information of the patient ROI image data. The property information includes ROI pixel data, and a label of the ROI artery type. However, generating property information of ROI data by other processes is also envisioned. Other processes for generating property information of ROI data include, but are not limited to analytical processing, mathematical calculating, algorithmic analyzing, classifying and labeling. A functional label, a temporal label, and an anatomical reference label are all examples of labeling that are used to further describe a property of a ROI. The resulting property information includes property descriptions of the ROI and ROI data.

The property information is analyzed at block 48. Analyzing the property information typically produces a measurement of the property information. In an exemplary embodiment, analyzing property information creates a measurement of a degree of calcification. Property information comprising ROI pixel data and a label of ROI artery type is processed to generate a coronary artery calcium measurement. The coronary artery calcium measurement includes a coronary artery score, mass or volume.

The property information is stored in a storage medium at block 50. The storage medium includes, but is not limited to, for example, a remote server, a DICOM object, or any computer based storage medium. The property information is stored for either a short or long period of time at a user's discretion. In an exemplary embodiment, property information including ROI pixel data, a label of the ROI artery type, and a result of a calculation of a coronary artery calcium score, mass, or volume value of the ROI is stored.

Property information is then available for retrieval and further analysis at block 52. If an improved protocol for generating property information of ROI data is developed, it is often desirable to implement the improved protocol. Since the stored property information includes ROI data and property descriptions of the ROI, the property information may be retrieved at a later date and processed by the new protocol for generating property information of ROI data. The new protocol for generating property information of ROI data typically includes the development of a second algorithm that is often an improvement on a first algorithm, or development of a second parameter, which differs from a first parameter used for the generating of the property information.

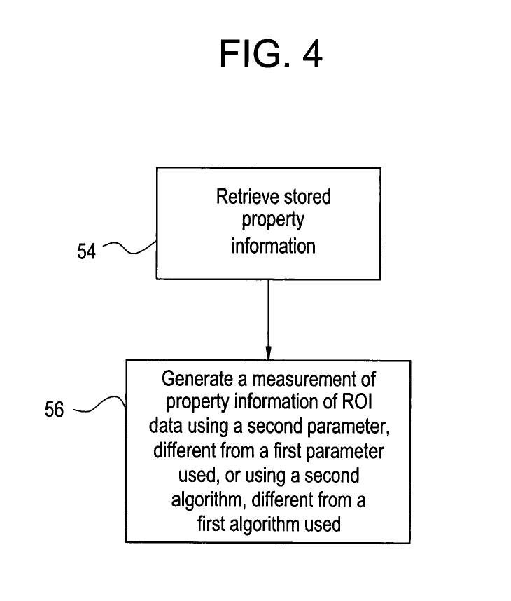

FIG. 4 shows an exemplary embodiment of the present invention in which further analysis is conducted. Examples of further analysis include retrieving stored property information at block 54. The stored property information is then processed, for example, by using the second parameter, which differs from the first parameter used to analyze the property information as shown at block 56. A measurement of the property information is obtained. Alternatively, the stored property information is processed to generate the measurement of the property information using the second algorithm, which differs from the first algorithm used to analyze the property information of the ROI data as shown at block 56. Further analysis also includes other methods of processing the stored property information including recalculations or reproductions of a portion of the property information. Since, for example, a new method of analyzing ROI data is likely to develop over time, an embodiment of the present invention allows a utilization of the new method of analyzing ROI data using ROI data gathered at some past time, rather than requiring an individual to acquire new ROI data. In an exemplary embodiment, further analysis includes calculation of a coronary artery calcium measurement of the ROI via the second algorithm different from the first algorithm used for an original calculation of the coronary artery calcium measurement. In another exemplary embodiment, further analysis includes calculation of a coronary artery calcium measurement via the second parameter different from the first parameter used for an original calculation of the coronary artery calcium measurement. The coronary artery calcium measurement includes coronary artery calcium score, mass, or volume.

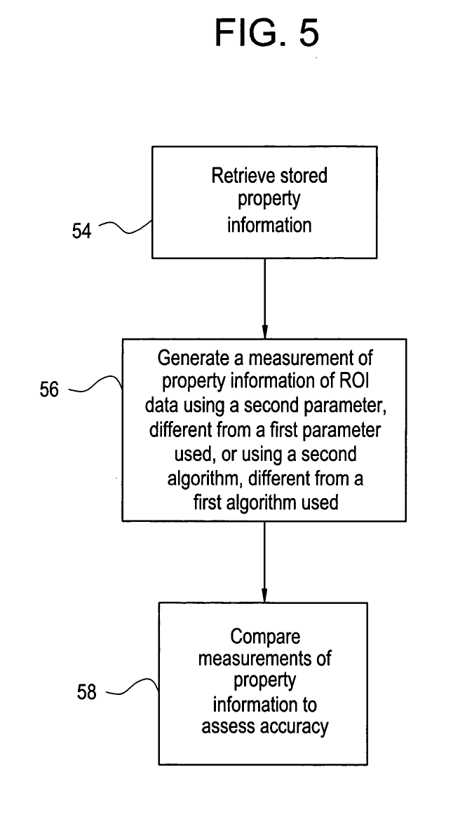

FIG. 5 shows an exemplary embodiment in which the further analysis shown in FIG. 4 is used to compare accuracy of property information. Further analysis by use of either using the second parameter, which differs from the first parameter used to analyze the property information, or using the second algorithm, which differs from the first algorithm used to analyze the property information at block 56, as described above, also allows a measurement of property information generated by a particular algorithm to be compared across a plurality of different algorithms at block 58. Comparing the measurement of property information generated by the particular algorithm across the plurality of different algorithms provides an evaluator with a basis from which to assess the accuracy of the particular algorithm. In an exemplary embodiment, comparing a measurement of property information generated by a particular CACS algorithm across a plurality of CACS algorithms allows a coronary artery calcium measurement to be compared with a different CACS algorithm generating a different coronary artery measurement while a user is only required to obtain ROI data once. Thus, inaccuracies introduced by the user are eliminated.

Although the preceding embodiments are discussed with respect to medical imaging, it is understood that the image acquisition and processing methodology described herein is not limited to medical applications, but may be used in non-medical applications. Furthermore, in an exemplary embodiment, the CT imaging system 1 and the processing device 32 are optionally in communication via a network such as, for example, the Internet.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for prospectively acquiring data of a region of interest for retrospective re-analysis, the method comprising:
obtaining region of interest data;
generating property information of said region of interest data;
analyzing said property information receptive to generating a measurement of said property information;
storing said property information; and
retrieving said property information receptive to further analysis.

2. The method of claim 1, wherein said obtaining region of interest data includes using at least one of:
a computed tomography imaging (CT) system;
a magnetic resonance imaging (MRI) system;
a positron emission tomography (PET) system;
a single photon emission computed tomography (SPECT) system;
an Ultrasound system; and
a X-ray system.

3. The method of claim 1, wherein said region of interest data comprises at least one of:
image data;
functional image data; and
temporal image data.

4. The method of claim 3, wherein said region of interest data further comprises at least one of:
voxel data including volume information for a three dimensional region of interest;
pixel data including area information for a two dimensional region of interest; and
spatio-temporal data including at least one of area and volume information over a time period.

5. The method of claim 1, wherein said generating property information of said region of interest data includes at least one of:
analytical processing;
mathematical calculating;
algorithmic analyzing;
classifying; and
labeling.

6. The method of claim 5, wherein said labeling comprises using at least one of:
a functional label;
a temporal label; and
an anatomical reference label.

7. The method of claim 1, wherein said property information includes at least one of said region of interest data and property descriptions of the region of interest.

8. The method of claim 1, wherein said storing said property information includes storing via at least one of:
a remote server;
a local server;
a DICOM object; and
a computer based storage medium.

9. The method of claim 7, wherein said further analysis includes at least one of:
processing said property information using a second parameter different from a first parameter used for said analyzing said property information; and
processing said property information using a second algorithm different from a first algorithm used for said analyzing said property information.

10. The method of claim 9 further comprising:
checking accuracy of said property information using at least one of said processing said property information using said second parameter and said processing said property information using said second algorithm.

11. A method for prospectively acquiring region of interest based data for retrospective re-analysis of a coronary artery calcification, the method comprising:
obtaining patient region of interest image data;
generating property information of said patient region of interest image data;
analyzing said property information receptive to generating a first measurement of said property information;
storing said property information; and
retrieving said property information receptive to further analysis.

12. The method of claim 11, wherein said obtaining patient image data includes using a computed tomography imaging system.

13. The method of claim 11, wherein said generating property information includes;
obtaining pixel data of a region of interest; and
labeling an artery type of said region of interest.

14. The method of claim 11, wherein said storing includes storing via at least one of:
a remote server;
a local server;
a DICOM object; and
a computer based storage medium.

15. The method of claim 11 wherein said first measurement of said property information includes calculating at least one of a first coronary artery calcium score, mass, and volume of said region of interest.

16. The method of claim 15, wherein said further analysis includes at least one of:
calculation of a second measurement using a second parameter different from a first parameter used for calculation of said first measurement, said second measurement includes calculating at least one of a second coronary artery calcium score, mass, and volume of said region of interest; and
calculation of said second measurement using a second algorithm different from a first algorithm used for calculation of said first measurement.

17. The method of claim 16 further comprising:
checking accuracy of said second measurement using at least one of calculation of said second measurement using said second parameter different from said first parameter and calculation of said second measurement using said second algorithm different from said first algorithm.

18. A system for prospectively acquiring data of a region of interest for retrospective re-analysis, the system comprising:
a data acquisition system;
an object disposed so as to be communicated with said data acquisition system, wherein said data acquisition system receives data related to said object; and
a processing device in communication with said data acquisition system, said processing device including software to implement a method comprising:
obtaining region of interest data;
generating property information of said region of interest data;
analyzing said property information receptive to generating a measurement of said property information;
storing said property information; and
retrieving said property information receptive to further analysis.

19. The system of claim 18, wherein said region of interest data comprises at least one of:
image data;
functional image data; and
temporal image data.

20. The system of claim 18, wherein said data acquisition system comprises at least one of:
a computed tomography imaging (CT) system;
a magnetic resonance imaging (MRI) system;
a positron emission tomography (PET) system;
a single photon emission computed tomography (SPECT) system;
an Ultrasound system; and
a X-ray system.

21. The system of claim 18, wherein said property information includes at least one of:
said region of interest data; and
a property description of said region of interest.

22. The system of claim 21, wherein said further analysis includes at least one of:
processing said property information using a second parameter different from a first parameter used for said analyzing said property information; and
processing said property information using a second algorithm different from a first algorithm used for said analyzing said property information.

23. The system of claim 18, wherein said processing device is in communication with said data acquisition system via a network.

24. The system of claim 23, wherein said network is the Internet.

25. A computer program product for prospectively acquiring data of a region of interest for retrospective re-analysis, the product comprising:
a storage medium readable by a processing circuit, said storage medium configured to store instructions for execution by said processing circuit, said processing circuit receptive to:
obtaining region of interest data;
generating a property information of said region of interest data;
analyzing said property information receptive to generating a measurement of said property information;
storing said property information; and
retrieving said property information receptive to further analysis.

26. The product of claim 25, wherein said region of interest data comprises at least one of:
image data;
functional image data; and
temporal image data.

27. The product of claim 25, wherein said generating said property information of said region of interest data includes at least one of:
analytical processing;
mathematical calculating;
algorithmic analyzing;
classifying; and
labeling.

28. The product of claim 27, wherein said labeling comprises using at least one of:
a functional label;
a temporal label; and
an anatomical reference label.

29. The product of claim 25, wherein said further analysis comprises at least one of:
processing said property information using a second parameter different from a first parameter used for said analyzing said property information to generate a first measurement;
processing said property information using a second algorithm different from a first algorithm used for said analyzing said property information to generate said first measurement; and
generating a second measurement of said property information.

30. The product of claim 29, wherein each of said first and second measurements include at least one of a coronary artery calcium score, mass, and volume.

31. The product of claim 30, wherein said first and second measurements are compared to each other to assess accuracy of one of said first and second measurements.
